(19) United States
(12) Patent Application Publication
(10) Pub. No.: US 2007/0227459 A1
(43) Pub. Date: Oct. 4, 2007

(54) Fish acclimation transfer line

(76) Inventor: Brad S. Gould, Chesterfield, MO (US)

Correspondence Address: Donald W. Meeker;Patent Agent, 924 East Ocean Front #E, Newport Beach, CA, 92661, US

(21) Appl. No.: 10/845,428

(22) Filed: May 12, 2004

(51) Int. Cl. A01K 63/00

(52) U.S. Cl. 119/248

(57) ABSTRACT

A fish acclimation siphon device with a rigid inverted U-shaped section which fits over the edge of an aquarium, a flexible hose attached to the outer end of the U-shaped section, and a needle valve attached to the end of the flexible hose that allows water from the aquarium to slowly mix drop by drop with the water the fish is accustomed to, after which the fish and the mixed water may be poured into the aquarium.

### BACKGROUND OF THE INVENTION

1. Field of the Invention

The present invention relates to the acclimation of fish to a new environment and particularly to a siphon device comprising a rigid inverted U-shaped section that fits over the edge of an aquarium, a flexible hose attached to the outer end of the U-shaped section, and a needle valve attached to the end of the flexible hose that allows water from the aquarium to slowly mix drop by drop with the water the fish is accustomed to, after which the fish and the mixed water may be dumped into the aquarium.

2. Description of the Prior Art

Most fish are extremely sensitive to temperature or pH changes and are made sick or are killed when they are removed from their tank and accustomed environment and moved to a new tank with water of different temperature or pH levels. Newly obtained fish are typically sent home in a sealed plastic bag, which is floated in the aquarium water for hours to acclimate the new fish to the temperature of the aquarium. However, adding incremental amounts of aquarium water to the plastic bag to acclimate the fish to the new pH levels is often bypassed or not completed, due to the inconvenience.

Prior art devices do not provide economical systems that can be used with the present practice of sending fish home in a plastic bag filled with water.

Prior art U.S. Pat. No. 6,640,749, issued Nov. 4, 2003 to Monnier, provides a method and device for packaging, transporting and acclimatization of exotic fish or aquatic plants. A process is provided for preparing, transporting and acclimatizing exotic fish or aquatic plants, employing a tank of rigid plastic material and a transparent plastic foil. The process includes: pre-filling the tank with water to between 50% and 80% of capacity; placing the fish or plants in the tank; purging the tank of air; sealing the tank with the foil; transporting the fish or aquatic plants; leveling the tank; punching two apertures in the foil; introducing water from an aquarium drop-by-drop into the first aperture; removing any excess water from the tank via the second aperture; after an acclimatization period, removing the foil from the tank; and transferring the fish or plants to the aquarium.

Prior art U.S. Pat. No. 3,771,544, issued Nov. 13, 1973 to Horvath, provides a syphon used with an aquarium tank and a separate filter tank, water being pumped from below filter material in the filter tank into the aquarium tank, the syphon having a long leg discharging filtered water near the bottom of the aquarium tank and having a short leg in the filter tank with a check valve at the end of the short leg preventing flow into the short leg allowing the syphon to have its short leg removed from the filter tank so the filter tank may be serviced, the check valve holding water in the syphon so it will automatically start on replacing the short leg in the filter tank, the check valve having a casing containing an upward facing valve seat, a valve guide containing a valve guide aperture over the valve seat, and a spherical valve engaging the valve seat and having a stem loosely extending through the valve guide aperture.

Prior art U.S. Pat. No. 6,591,783, issued Jul. 15, 2003 to Lajeunesse, shows a marine life packaging and acclimatization system. A method and apparatus are provided for packaging live fish in sealed containers. A plastic container is partially filled with water, before receipt of fish, with at least some of the air evacuated from the container and replaced with a gas. An airtight lid is sealed to the container capturing a layer of gas, such as oxygen, in a void over the water. The use of a clear or transparent container and lid allows the container to operate as a miniature aquarium allowing storage of the fish for an extended period of time. The fish are acclimated to a point-of-use aquarium by weighting of the container for placement in the aquarium. The container includes printed marks for puncture holes to allow the exchange of water between the container and the receiving aquatic environment. The puncture holes permit a predetermined amount of air to escape the container while slowing being displaced by the water of the aquatic environment. The container is designed to sink providing an absolute indicator that fluid admixing is complete. The lid of the container can then be removed allowing the fish to enter their new environment, which is now the same as the water within the container.

Prior art U.S. Pat. No. 3,958,393, issued May 25, 1976 to Whitener, claims a package for transporting live fish consisting of a pliable, open-mouthed bag having an elastic band secured around its mouth and partially gathering said mouth. The mode of use of said package consists of filling the bag partially with water and fish, twisting the sack intermediate the water and the open mouth to form a seal, and everting the portion of the bag between its mouth and the twist around the portion thereof containing water and fish. An open, buoyant ring may be secured in the sack mouth by the elastic band to float the bag in an aquarium to acclimate the fish to the water temperature of the aquarium.

Prior art U.S. Pat. No. 4,188,909, issued Feb. 19, 1980 to Spivak, describes a device for introducing and acclimation of marine inhabitants to a new environment. The device, containing the new inhabitant and the water in which it was transported, is hung from an edge of the aquarium with a portion of the device submerged. A quantity of water from the aquarium, which has been poured into another portion of the device, is allowed to drain at a controlled rate into the portion containing the new inhabitant thereby gradually diluting the transportation water. When the transportation water has been fully diluted and its temperature has become equal to that of the water in the aquarium, the device may be opened to allow the inhabitant to swim out, with minimal shock to bodily systems.

Prior art U.S. Pat. No. 3,491,722, issued Jan. 27, 1970 to Levitov, puts forth an introduction tank of transparent glass or plastic that is immersed in an aquarium, to which it is secured, and receives new fish with their transport water which are ultimately to be added to the aquarium. Provision is made for a regular flow of aquarium water into the tank, as by way of an inlet port in a wall or corner of the tank, such port being valve-controlled, so that the transport water is gradually diluted with aquarium water until the composition and temperature of the tank are nearly those of the aquarium water. Shock to the fish is minimized when they are transferred to the aquarium.

Prior art U.S. Pat. No. 4,861,465, issued Aug. 29, 1989 to Augustyniak, indicates an apparatus for a recirculating aquarium water supply system having a tank with a discharge control device for maintaining the level of the water in the tank and incorporating an overflow receptacle in the tank and a pre-filter receptacle outside the tank filled by a siphon from the overflow receptacle, the pre-filter receptacle having a sponge-like filter serving as a divider fitted therein between the discharge of the siphon and drain of the pre-filter receptacle, the drain discharging onto a diffuser plate which drips the water onto a cylindrical filter made from a wrapping of fibrous batting material which is saturated by the water and drips through a gravel filled container which discharges through a labyrinthian path in several interconnected chambers to a pump container from which the water is pumped back into the tank by a U-shaped nozzle which below the bend of the U has a series of slots formed therein for discharging a slow moving spray over the top layer of water in the tank, the water also discharging through the lower end of the leg of the nozzle. The nozzle serves as a water level maintaining device by aspirating air through said slots to prevent the nozzle from acting as a reverse siphon when the pump stops.

Prior art U.S. Pat. No. 3,261,471, issued Jul. 19, 1966 to Halpert, is for an aeration and filtration system for fish tanks, which may be mounted on the outside of the tank.

Prior art U.S. Pat. No. 2,341,129, issued Feb. 8, 1944 to Thompson, shows a siphon assembly used in chemistry.

What is needed is an economical device for acclimating fish to a new water environment that can be used with the present practice of sending home fish in a plastic bag filled with water.

### SUMMARY OF THE INVENTION

An object of the present invention is to provide a simple economical three piece device comprising a rigid inverted U-shaped tube in a fish tank, a flexible hose extending from the tube, and a needle valve at the end as a simple water siphon transfer device to drip water into a container holding the new fish and the plastic bag filled with water from the store by cutting open the bag and allowing the new aquarium water to drip slowly drop by drop into the container to mix with the water from the store for acclimating new fish to an existing aquarium.

Another object of the present invention is to provide a fish acclimation siphon device that is clear, thereby allowing one to see if any matter is flowing out of the tank.

One more object of the present invention is to provide a fish acclimation siphon device that has small openings so no fish or plants can fit through, thereby only allowing water to pass through the device.

A further object of the present invention is to provide a fish acclimation siphon device that may be used with an existing fluid holding container, which does not require a buying a specialized external container.

In brief, a fish acclimation device for acclimating new fish to a fish tank. The device comprises a rigid inverted U-shaped tube sufficiently long to fit over a top of a fish tank containing water with an open first end of the tube submerged below water. The device also comprises a flexible hose extending from the U-shaped tube downward into an external container positioned below the water level of the fish tank, into which external container a plastic bag holding one or more fishes in water from an external source has been placed with the plastic bag cut open. The tube is preferably a rigid clear transparent tube and the hose is preferably a clear transparent hose, which are both adapted for viewing a liquid flowing through them to insure that no fish or solid matter flow out of the fish tank.

The device further comprises a needle valve attached to the end of the flexible hose, which is adapted to be positioned in the external container. The needle valve comprises a housing with a narrow opening therethrough and a control knob for adjusting the internal needle valve adapted for allowing flowthrough as low as a drop of water at a time. The needle valve drips water siphoned from the fish tank through the tube and hose a drop at a time for slowly mixing the fish tank water with the external water in the container, thereby acclimating the fish to the water in the fish tank prior to placing the fish in the fish tank. The tube, hose, and valve all have openings too narrow to admit fish or plants therethrough.

An advantage of the present invention is that it can be used with the plastic bag that new fish are provided in.

Another advantage of the present invention is that it introduces the new water very slowly.

A further advantage of the present invention is that it eliminates pH and temperature shock.

An additional advantage of the present invention is that the user can see through the device.

One more advantage of the present invention is it is easy to use.

Yet another advantage of the present invention is that it is inexpensive.

Still another advantage of the present invention is that no fish or plants can pass through it.

An ensuing advantage of the present invention is that is economical to manufacture.

A corollary advantage of the present invention is that it does not require a specialized external container.

A final advantage of the present invention is that it can be used with all standard sizes of fish tanks.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of a fish tank and a container in cross-section with a new fish and opened plastic bag of water in the container and the fish acclimation water transfer line of the present invention extending between them to siphon water from the fish tank into the container a drop at a time through the needle valve at the end of the line.

### BEST MODE FOR CARRYING OUT THE INVENTION

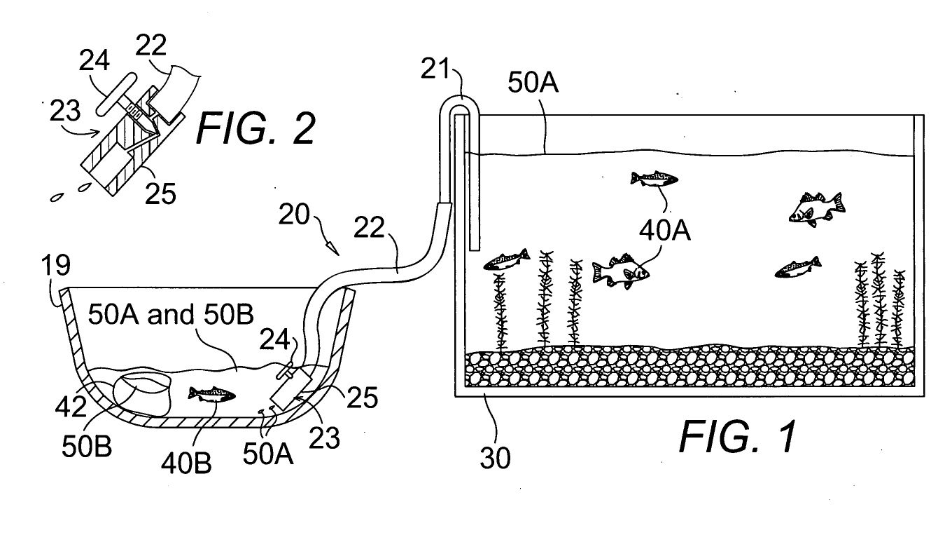

In FIG. 1, a fish acclimation device 20 for acclimating new fish 40B to a fish tank 30. The device 20 comprises a rigid inverted U-shaped tube 21 sufficiently long to fit over a top of a fish tank 30 containing water 50A with a first end of the tube 21 immersed in the water 50A. The rigid inverted U-shaped tube 21 is sufficiently long so that the open first end of the tube 21 will always be submerged below water 50A in all standard sizes of fish tanks 30.

The device 20 also comprises a flexible hose 22 extending from the U-shaped tube 21 downward into an external container 19 positioned below the water level 50A of the fish tank 30, into which external container 19 a plastic bag 42 holding one or more fish 40B in water 50B from an external source has been placed with the plastic bag 42 cut open, as shown in FIG. 1. The tube 21 is preferably a rigid clear transparent tube and the hose 22 is preferably a clear transparent hose, which are both adapted for viewing the water 50A from the fish tank 30 flowing through them to insure that no fish 40A or solid matter flow out of the fish tank 30.

The device 20 further comprises a needle valve 23 attached to the end of the flexible hose 22, which is adapted to be positioned in the external container 19. The needle valve 23 comprises a housing 23 with a narrow opening therethrough and a control knob 24 for adjusting the internal needle valve (not shown) adapted for allowing flowthrough as low as a drop of water 50A at a time through the housing 23. The needle valve 23 is adapted to drip water 50A siphoned from the fish tank 30 through the tube 21 and hose 22 a drop at a time for slowly mixing the fish tank water 50A with the external water 50B in the container 19, as seen in FIG. 1, thereby acclimating the new fish 40B to the water 50A in the fish tank 30 prior to placing the fish 40B in the fish tank 30.

The tube 21, hose 22, and valve 23 all have openings too narrow to admit fish 40A and 40B or plants therethrough.

In practice, the bag 42 containing the new fish 40B would be preferably placed inside of a clean external container 19 and would be opened by cutting the bag 42. Alternately, the new fish 40B may be placed in the external container 19 by opening the top of the bag 42 and gently pouring the new fish 40B and their accompanying water 50B into the external container 19. The external container 19 would be placed in a position lower than the water level 50A of the fish tank 30.

The user would check the control knob 24 of the needle valve 23 to be sure it is in a closed position. Next, the entire siphon device 20 would be submerged under the water 50A in the aquarium 30 to fill it. The user would place one finger over the open end of the U-shaped section 21 while lifting the siphon device 20 from the aquarium 30, thereby keeping the water 50A inside of the siphon device 20. The rigid inverted U-shaped section 21 would then be fitted over the edge of the aquarium 30 with its open end submerged under the water 50A of the tank 30, the user would then remove his/her finger from the submerged open end of the U-shaped section 21. The flexible hose 22 attached to the outer end of the U-shaped section 21 would be extended to the external container 19 and the needle valve 23, which is attached to the end of the flexible hose 22, would be placed in the bottom of the external container 19. The control knob 24 of the needle valve 23 would then be opened to allow gravity to pull water 50A from the aquarium 30 a drop at a time, as shown in FIG. 1. The aquarium water 50A will slowly mix drop by drop with the water 50B the new fish 40B is accustomed to, after which the fish 40B and the mixed water 50A and 50B may be poured into the aquarium 30.

It is understood that the preceding description is given merely by way of illustration and not in limitation of the invention and that various modifications may be made thereto without departing from the spirit of the invention as claimed.

1. A fish acclimation device for acclimating new fish to a fish tank, the device comprising in combination:
a rigid inverted U-shaped tube attached over a top of a fish tank containing water with a first end of the tube immersed in the water and a second end of the tube extending down from the top of the fish tank outside of the fish tank, the U-shaped tube structured of a clear rigid material so that it stays in place on the fish tank and so that water flowing therethrough from the fish tank can be viewed through the U-shaped tube, the rigid inverted U-shaped tube being sufficiently long so that the first end of the tube will always be submerged below water in all standard sizes of fish tanks;
a flexible hose extending from the tube downward into an external container positioned below a water level of the fish tank, the external container containing a plastic bag holding at least one fish in water from an external sources, the plastic bag being open to allow the water from the external source to mix with the water from the fish tank to acclimate the at least one fish to the water in the fish tank; and
a needle valve attached to the end of the flexible hose positioned in the external container, the needle valve adjusted to drip water siphoned by gravity feed from the fish tank through the tube and hose a drop at a time for slowly mixing the fish tank water with the water from the external source in the container for acclimating the at least one fish to the water in the fish tank prior to placing the at least one fish in the fish tank, the needle valve comprising a housing with a narrow opening therethrough and a control knob for adjusting the internal needle valve adapted for allowing flowthrough as low as a drop of water at a time through the housing;
wherein the tube, hose, and valve each have openings too narrow to admit fish and plants therethrough.

2. (canceled)

3. The device of claim 1 wherein the tube is preferably a rigid clear transparent tube and the hose is preferably a clear transparent hose both adapted for viewing a liquid flowing through them to insure that no fish or solid matter flow out of the fish tank.

4. (canceled)

5. (canceled)
